(19) United States
(12) Patent Application Publication
(10) Pub. No.: US 2025/0181635 A1
(43) Pub. Date: Jun. 5, 2025

(54) INFORMATION PROCESSING APPARATUS, INFORMATION PROCESSING METHOD, INFORMATION PROCESSING SYSTEM, AND NON-TRANSITORY COMPUTER READABLE MEDIUM

(71) Applicant: NEC CORPORATION, Minato-ku, Tokyo (JP)

(72) Inventors: Ryo KAWAI, Tokyo (JP); Noboru Yoshida, Tokyo (JP); jianquan Liu, Tokyo (JP); Satoshi Yamazki, Tokyo (JP); Tingting dong, Tokyo (JP); Karen Stephen, Tokyo (JP); Youhei Sasaki, Tokyo (JP); Naoki Shindou, Tokyo (JP); Yuta Namiki, Tokyo (JP)

(73) Assignee: NEC CORPORATION, Minato-ku, Tokyo (JP)

(21) Appl. No.: 18/839,871

(22) PCT Filed: Apr. 26, 2022
(86) PCT No.: PCT/JP2022/018892

§ 371 Date: Aug. 20, 2024

(51) Int. Cl. G06F 16/583; G06F 16/538; G06T 5/30; G06T 7/70

(52) U.S. Cl. CPC G06F 16/5854; G06F 16/538; G06T 5/30; G06T 7/70

(57) ABSTRACT

An information processing apparatus (100) includes an estimation unit (115) and a display control unit (119). The estimation unit (115) estimates, based on a plurality of query images acquired by photographing a subject performing a predetermined action a plurality of times, and a reference image indicating a person associated with a predetermined pose, a pose of the subject indicated in each of the plurality of query images. In a case where a query image in which an estimation result is different is included in the plurality of query images, the display control unit (119) causes a display unit to display a query image in which the different estimation is made.

### TECHNICAL FIELD

The present invention relates to an information processing apparatus, an information processing method, an information processing system, and a storage medium.

### BACKGROUND ART

For example, an image search apparatus described in Patent Document 1 includes a pose estimation unit, a feature value extraction unit, a query generation unit, and an image search unit.

The pose estimation unit described in the same document recognizes, from an input image, pose information of a search target configured of a plurality of feature points. The feature value extraction unit described in the same document extracts a feature value from the pose information and the input image. The query generation unit described in the same document generates a search query from an image database in which the feature value is stored in association with the input image, and pose information specified by a user. The image search unit described in the same document searches, from the image database, for an image including a similar pose according to the search query.

Note that, Patent Document 2 describes a technique in which a feature value of each of a plurality of keypoints of a human body included in an image is computed, an image including a human body whose pose is similar or a human body whose motion is similar is searched for based on the computed feature value, and human bodies whose pose or motion is similar to each other are classified in a batch manner. Non-Patent Document 1 describes a technique related to skeleton estimation of a person.

### RELATED DOCUMENT

### Patent Document

Patent Document 1: Japanese Patent Application Publication No. 2019-091138
Patent Document 2: International Patent Publication No. WO2021/084677

### Non-Patent Document

Non-Patent Document 1: Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, pp. 7291 to 7299

### DISCLOSURE OF THE INVENTION

### Technical Problem

Patent Document 1 describes a technique for estimating a pose or an action, based on an image. However, in Patent Document 1, since it is not known whether a pose is accurately estimated, it is difficult to improve accuracy of estimating a pose of a subject indicated in an image.

Note that, both of Patent Document 2 and Non-Patent Document 1 do not disclose a technique for improving accuracy of detecting, from an image acquired by photographing a person, the person in a predetermined pose.

One example of an object of the present invention is, in view of the above-described problem, to provide an information processing apparatus, an information processing method, an information processing system, and a storage medium that solve a task of improving accuracy of estimating a pose of a subject indicated in an image.

### Solution to Problem

One aspect of the present invention provides an information processing apparatus including:
an estimation unit that estimates, based on a plurality of query images to be acquired based on a plurality of times of photographing during performing a predetermined action, and a reference image indicating a person associated with a predetermined pose, a pose of a subject indicated in each of the plurality of query images; and,
in a case where a query image in which an estimation result is different is included in the plurality of query images, a display control unit that causes a display unit to display a query image in which the different estimation is made.

One aspect of the present invention provides an information processing system including:
the above-described information processing apparatus; and
one or a plurality of photographing units that perform the plurality of times of photographing.

One aspect of the present invention provides an information processing method including,
by a computer:
estimating, based on a plurality of query images to be acquired based on a plurality of times of photographing during performing a predetermined action, and a reference image indicating a person associated with a predetermined pose, a pose of a subject indicated in each of the plurality of query images; and, in a case where a query image in which an estimation result is different is included in
the plurality of query images, causing a display unit to display a query image in which the different estimation is made.

One aspect of the present invention provides a storage medium storing a program for causing a computer to execute:
estimating, based on a plurality of query images to be acquired based on a plurality of times of photographing during performing a predetermined action, and a reference image indicating a person associated with a predetermined pose, a pose of a subject indicated in each of the plurality of query images; and,
in a case where a query image in which an estimation result is different is included in the plurality of query images, causing a display unit to display a query image in which the different estimation is made.

### Advantageous Effects of Invention

One aspect of the present invention enables to provide an information processing apparatus, an information processing method, an information processing system, and a storage medium that solve a task of improving accuracy of estimating a pose of a subject indicated in an image.

### BRIEF DESCRIPTION OF THE DRAWINGS

FIG. 1 is a diagram illustrating an overview of an information processing apparatus according to an example embodiment 1.

FIG. 2 is a diagram illustrating an overview of an information processing system according to the example embodiment 1.

FIG. 3 is a flowchart illustrating an overview of information processing according to the example embodiment 1.

FIG. 4 is a diagram illustrating a detailed functional configuration example of the information processing system according to the example embodiment 1.

FIG. 5 is a diagram illustrating a configuration example of reference information including a reference image associated with a call pose.

FIG. 6 is a diagram illustrating a configuration example of weight information indicating a weight associated with a call pose.

FIG. 7 is a diagram illustrating a functional configuration example of a similarity acquisition unit according to the example embodiment 1.

FIG. 8 is a diagram illustrating a physical configuration example of the information processing apparatus according to the example embodiment 1.

FIG. 9 is a flowchart illustrating one example of pose estimation processing according to the example embodiment 1.

FIG. 10 is a diagram illustrating one example of a method of thinning out a part from a plurality of frame images.

FIG. 11 is a flowchart illustrating a detailed example of similarity acquisition processing according to the example embodiment 1.

FIG. 12 is a flowchart illustrating one example of estimation support processing according to the example embodiment 1.

FIG. 13 is a diagram illustrating an example of a false estimation pattern.

FIG. 14 is a diagram illustrating a detailed functional configuration example of an information processing system S2 according to an example embodiment 2.

### EXAMPLE EMBODIMENT

Hereinafter, example embodiments according to the present invention are described by using the drawings. Note that, in all drawings, a similar constituent element is indicated by a similar reference sign, and description thereof is omitted as necessary.

### Example Embodiment 1

### (Overview)

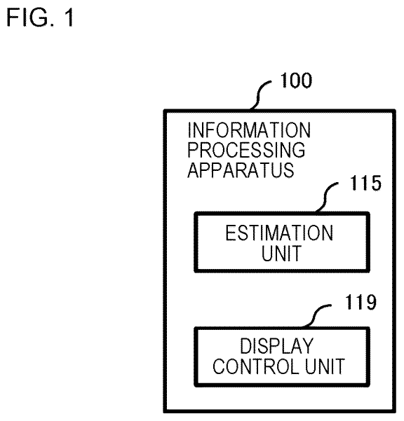

FIG. 1 is a diagram illustrating an overview of an information processing apparatus 100 according to an example embodiment 1. The information processing apparatus 100 includes an estimation unit 115 and a display control unit 119.

The estimation unit 115 estimates, based on a plurality of query images to be acquired based on a plurality of times of photographing during performing a predetermined action, and a reference image indicating a person associated with a predetermined pose, a pose of a subject indicated in each of the plurality of query images.

In a case where a query image in which an estimation result is different is included in the plurality of query images, the display control unit 119 causes a display unit to display a query image in which the different estimation is made.

According to the information processing apparatus 100, it becomes possible to provide the information processing apparatus 100 that solves a task of improving accuracy of estimating a pose of a subject indicated in an image.

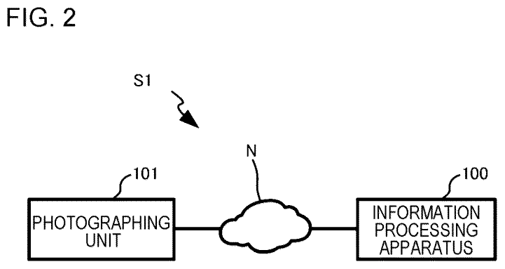

FIG. 2 is a diagram illustrating an overview of an information processing system S1 according to the example embodiment 1. The information processing system S1 includes the information processing apparatus 100, and one or a plurality of photographing units 101 that perform a plurality of times of photographing.

According to the information processing system S1, it becomes possible to provide the information processing system S1 that solves a task of improving accuracy of estimating a pose of a subject indicated in an image.

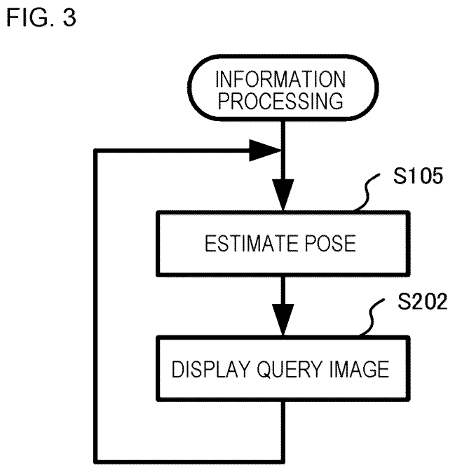

FIG. 3 is a flowchart illustrating an overview of information processing according to the example embodiment 1.

The estimation unit 115 estimates, based on a plurality of query images to be acquired based on a plurality of times of photographing during performing a predetermined action, and a reference image indicating a person associated with a predetermined pose, a pose of a subject indicated in each of the plurality of query images (step S105).

In a case where a query image in which an estimation result is different is included in the plurality of query images, the display control unit 119 causes a display unit to display a query image in which the different estimation is made (step S202).

According to the information processing, it becomes possible to provide the information processing system S1 that solves a task of improving accuracy of estimating a pose of a subject indicated in an image.

### (Details)

Hereinafter, a detailed example of the information processing system S1 according to the example embodiment 1 is described.

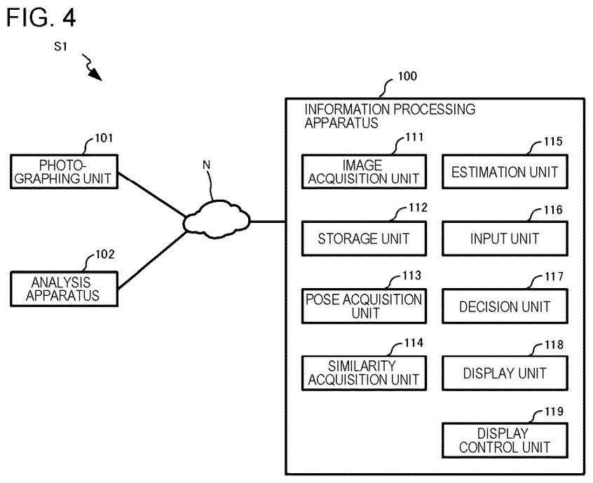

FIG. 4 is a diagram illustrating a detailed functional configuration example of the information processing system S1 according to the example embodiment 1. The information processing system S1 includes the photographing unit 101, the information processing apparatus 100, and an analysis apparatus 102. The photographing unit 101, the information processing apparatus 100, and the analysis apparatus 102 are connected via wired connection, wireless connection, or a network N configured by combining these, and can mutually transmit and receive information.

The photographing unit 101 photographs a person (subject) performing a predetermined action. The photographing unit 101 is, for example, a camera that is installed in a store of a financial institution such as a bank, and photographs an operator operating an automated teller machine (ATM).

Note that, the photographing unit 101 is not limited to a camera for photographing an operator of an ATM, but may be a camera that photographs inside a store such as a bank, or may be a camera installed in various stores and the like other than a financial institution.

The photographing unit 101 photographs a predetermined photographing area, and transmits image information indicating a moving image to the information processing apparatus 100.

Specifically, the photographing unit 101 sequentially photographs a plurality of times in time series at a predetermined framerate. The photographing unit 101 generates frame information including a frame image by each photographing. The photographing unit 101 transmits, to the information processing apparatus 100, frame information including each of frame images in time series via the network N.

The analysis apparatus 102 is an apparatus that analyzes an image. The analysis apparatus 102 acquires image information generated by the photographing unit 101 via the network N. In the present example embodiment, an example in which the analysis apparatus 102 acquires image information from the photographing unit 101 via the information processing apparatus 100 is described, however, image information may be directly acquired from the photographing unit 101.

The analysis apparatus 102 is an apparatus that analyzes an image included in acquired image information.

Specifically, the analysis apparatus 102 includes one or a plurality of analysis functions that perform processing (analysis processing) for analyzing an image. The analysis functions included in the analysis apparatus 102 are one or a plurality such as an object detection function (1), a face analysis function (2), a human type analysis function (3), a pose analysis function (4), an action analysis function (5), an external appearance attribute analysis function (6), a gradient feature analysis function (7), a color feature analysis function (8), and a traffic flow analysis function (9).

The object detection function (1) detects a person and a thing from an image. The object detection function can also derive a position of a person and a thing within an image. As a model to be applied to object detection processing, for example, there is you only look once (YOLO). The object detection function detects, for example, an operator, a mobile phone (including a smartphone.), a wheelchair, and the like. Further, for example, the object detection function derives a position of a detected person and thing.

The face analysis function (2) detects a face of a person from an image, and performs extraction of a feature value (face feature value) of the detected face, classification (classifying) of the detected face, and the like. The face analysis function can also derive a position of a face within an image. The face analysis function can also decide identity of a person detected from a different image, based on a similarity between face feature values of the person detected from the different image, and the like.

The human type analysis function (3) performs extraction of a human feature value (e.g., a value indicating an overall feature such as obesity of body shape, height, and clothing) of a person included in an image, classification (classifying) of a person included in the image, and the like. The human type analysis function can also determine a position of a person within an image. The human type analysis function can also decide identity of a person included in a different image, based on a human feature value and the like of the person included in the different image.

The pose analysis function (4) generates pose information indicating a pose of a person. Th pose information includes, for example, a pose estimation model of a person. The pose estimation model is a model in which joints of a person to be estimated from an image are connected. The pose estimation model is configured of a plurality of model elements associated with a joint element associated with a joint, a body trunk element associated with a body trunk, a bone element associated with a bone that connects between joints, and the like. For example, the pose analysis function detects a joint point of a person from an image, and generates a pose estimation model by connecting the joint points.

Then, the pose analysis function estimates a pose of a person by using information on the pose estimation model, and performs extraction of a feature value (pose feature value) of the estimated pose, classification (classifying) of a person included in an image, and the like. The pose analysis function can also decide identity of a person included in a different image, based on a pose feature value and the like of the person included in the different image.

For example, the pose analysis function generates a pose estimation model of a call pose, a wheelchair pose, and the like, and extracts a pose feature value in these poses. The call pose is a pose of making a call using a mobile phone. The wheelchair pose is a pose of a person using a wheelchair.

In the pose analysis function, for example, the technique disclosed in Patent Document 2 and Non-Patent Document 1 can be applied.

Action analysis processing (5) can estimate a motion of a person by using information on a pose estimation model, a change in a pose, and the like, and perform extraction of a feature value (motion feature value) of the motion of the person, classification (classifying) of a person included in an image, and the like. In the action analysis processing, it is also possible to estimate height of a person, and determine a position of a person within an image by using information on a stick figure model. The action analysis processing can estimate, from an image, an action such as a change or a transition in a pose, movement (a change or a transition in a position), and extract a motion feature value of the action.

The external appearance attribute analysis function (6) can recognize an external appearance attribute accompanying a person. The external appearance attribute analysis function performs extraction of a feature value (external appearance attribute feature value) related to a recognized external appearance attribute, classification (classifying) of a person included in an image, and the like. The external appearance attribute is an attribute in terms of external appearance, and includes, for example, one or more of a color of clothing, a color of a shoe, a hairstyle, wearing or non-wearing of a hat, a necktie, eye glasses, and the like, and the like.

The gradient feature analysis function (7) extracts a feature value (gradient feature value) of a gradient in an image. In gradient feature detection processing, for example, a technique such as SIFT, SURF, RIFF, ORB, BRISK, CARD, and HOG can be applied.

The color feature analysis function (8) can detect an object from an image, and perform extraction of a feature value (color feature value) of a color of the detected object, classification (classifying) of the detected object, and the like. The color feature value is, for example, a color histogram, and the like. The color feature analysis function can detect, for example, a person and a thing included in an image.

The traffic flow analysis function (9) can derive a traffic flow (movement trajectory) of a person included in a video by using, for example, a decision result on identity in any of the above-described analysis functions (2) to (6). Specifically, for example, by connecting a person being decided to be identical between different images in time series, a traffic flow of the person can be derived. Note that, the traffic flow analysis function can also derive a traffic flow among a plurality of videos acquired by photographing a different photographing area, in a case where videos photographed by a plurality of the photographing units 101 that photograph a different photographing area are acquired, and the like.

The image feature value includes, for example, a detection result of an article in the object detection function, a face feature value, a human feature value, a pose feature value, a motion feature value, an external appearance attribute feature value, a gradient feature value, a color feature value, and a traffic flow.

Note that, each of the analysis functions (1) to (9) may use an analysis result performed by another analysis function as necessary. The information processing apparatus 100 may include an analysis unit including the functions of the analysis apparatus 102.

The information processing apparatus 100 according to the example embodiment 1 is an apparatus that estimates a pose of a person included in a frame image. As illustrated in FIG. 4, the information processing apparatus 100 functionally includes an image acquisition unit 111, a storage unit 112, a pose acquisition unit 113, a similarity acquisition unit 114, the estimation unit 115, an input unit 116, a decision unit 117, a display unit 118, and the display control unit 119.

The image acquisition unit 111 acquires, from the photographing unit 101, image information indicating a moving image. Specifically, the image acquisition unit 111 acquires a plurality of frame images in time series to be acquired by a plurality of times of photographing being sequential in time series.

Specifically, the image acquisition unit 111 acquires, from the photographing unit 101, frame information including each of a plurality of frame images in time series. The image acquisition unit 111 stores the acquired frame information.

The storage unit 112 is a storage unit for storing various pieces of information. The storage unit 112 stores in advance, for example, reference information 112a indicating a reference image, weight information 112b indicating a weight, and the like.

The reference image is an image of a person associated with a predetermined pose. The reference image is an image to be referred to for estimating a pose of a person included in a query image, and is set in the storage unit 112 by optional selection. The predetermined pose is, for example, a call pose, a wheelchair pose, and the like.

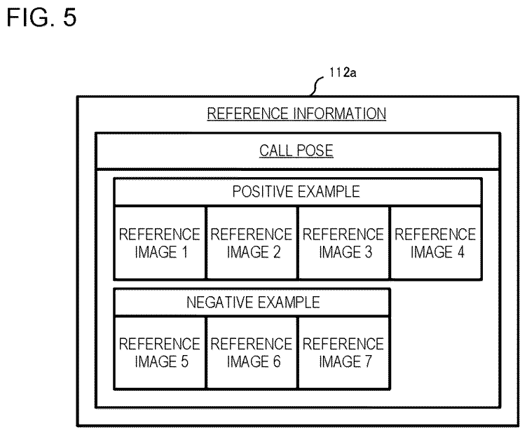

FIG. 5 is a diagram illustrating a configuration example of the reference information 112a including a reference image associated with a call pose. The reference information 112a illustrated in FIG. 5 includes, for example, a positive example and a negative example.

The positive example is a reference image of a person in a predetermined pose. The positive example (specifically, reference images 1 to 4) illustrated in FIG. 5 is a reference image of a person in a call pose, and, for example, indicates a person and the like making a call while standing and holding a mobile phone in his/her right or left hand.

The negative example is a reference image of a person who is not in a predetermined pose. As the negative example, it is preferable to select an image of a person not being in a predetermined pose, but in a pose similar to the predetermined pose. The negative example (specifically, reference images 5 to 7) illustrated in FIG. 5 is a reference image of a person not being in a call pose, and indicates, for example, a person and the like in a standing pose without holding a mobile phone.

Note that, the reference information 112a may include some reference images, as far as the reference information 112a includes at least one reference image. Further, the reference information 112a may include only a positive example.

The weight is a value indicating a degree with which each of model elements is made important in order to derive a similarity between pose estimation models in a predetermined pose. The weight information 112b includes a weight of each of model elements for each predetermined pose.

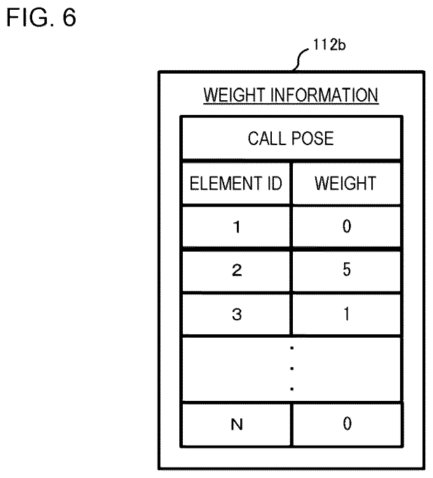

FIG. 6 is a diagram illustrating a configuration example of the weight information 112b indicating a weight associated with a call pose. The weight information 112b illustrated in FIG. 5 associates an element ID with a weight in a call pose. The element ID is information for identifying a model element. The element ID is, for example, a number to be appropriately given to each of a body trunk element, a bone element associated with an upper portion and a lower portion of left and right arms, a femur and a cruris of left and right legs, and the like, and a joint element. The weight is defined for each model element in a predetermined pose. FIG. 5 illustrates an example in which the weight is an integer of 0 or more, however, a weight setting method may be changed as necessary.

For example, in a call pose, since a person makes a call while holding a mobile phone, the weight to be set for the arm is larger than the weight to be set for the leg. Further, for example, in a call pose in a case where a person makes a call using his/her right hand, the weight to be set for the right hand is larger than the weight to be set for the left hand.

The pose acquisition unit 113 acquires, from the storage unit 112, a plurality of reference images associated with a predetermined pose such as a call pose, and then, acquires first pose information, based on the plurality of acquired reference images.

The first pose information is information indicating a pose of a person indicated in each of a plurality of reference images associated with a predetermined pose. The first pose information includes, for example, a first model being a pose estimation model related to a person indicated in a reference image.

Further, the pose acquisition unit 113 acquires, from the image acquisition unit 111, a frame image in time series, and acquires a query image by thinning out a part from the frame image in time series. Then, the pose acquisition unit 113 acquires second pose information, based on the acquired query image.

The second pose information is information indicating a pose of a subject indicated in a query image. The second pose information includes, for example, a second model being a pose estimation model related to a subject indicated in a query image.

Specifically, for example, the pose acquisition unit 113 transmits, to the analysis apparatus 102, each of an acquired reference image and an acquired query image via the network N. In a case where a reference image is transmitted to the analysis apparatus 102, the pose acquisition unit 113 acquires, from the analysis apparatus 102, first pose information including a first model related to a person indicated in the reference image. In a case where a query image is transmitted to the analysis apparatus 102, the pose acquisition unit 113 acquires, from the analysis apparatus 102, second pose information including a second model related to a person indicated in the query image.

The similarity acquisition unit 114 derives a similarity related to a pose between a subject indicated in a query image, and a person indicated in a reference image for each of combinations of a query image in time series, and a plurality of reference images associated with a predetermined pose.

The similarity is a value indicating a degree of similarity between pose estimation models in a predetermined pose.

For example, the similarity acquisition unit 114 acquires, from the pose acquisition unit 113, a first model of a person indicated in each of a plurality of reference images associated with a predetermined pose. Further, the similarity acquisition unit 114 acquires, from the pose acquisition unit 113, a second model of a subject indicated in each of query images in time series. The similarity acquisition unit 114 derives a similarity by using a first model and a second model for each of combinations of the first model and the second model.

The similarity includes an overall similarity and an element similarity.

The overall similarity is a value indicating a degree of overall similarity between a first model and a second model in a predetermined pose, specifically, an overall similarity between a first model and a second model.

The element similarity is a similarity for each model element associated between a first model and a second model in a predetermined pose, specifically, a similarity for each model element associated between a first model and a second model.

Note that, the similarity may include at least one of the overall similarity and the element similarity.

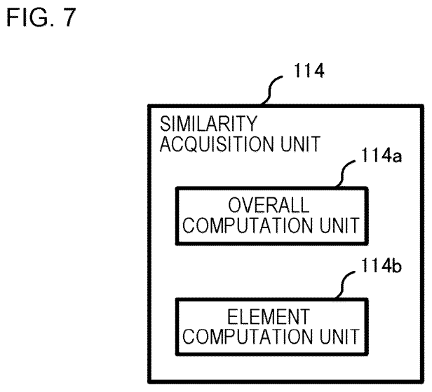

FIG. 7 is a diagram illustrating a functional configuration example of the similarity acquisition unit 114 according to the present example embodiment. The similarity acquisition unit 114 includes an overall computation unit 114a, and an element computation unit 114b.

The overall computation unit 114a derives an overall similarity between a first model and a second model. Specifically, the overall computation unit 114a derives an overall similarity by using a weight associated with a predetermined pose included in the weight information 112b, and an element similarity to be derived by the element computation unit 114b.

For example, in a case where the overall computation unit 114a acquires a similarity of each model element from the element computation unit 114b, the overall computation unit 114a derives a product of each similarity of a model element by a weight of an associated model element, and adds the product acquired for each model element configuring a pose estimation model. A value to be acquired as a result of the addition is an overall similarity.

The element computation unit 114b derives an element similarity being a similarity for each model element associated between a first model and a second model. For example, the element computation unit 114b derives an element similarity, based on a size, a length, a tilt, and the like, for each model element associated with a first model and a second model.

The estimation unit 115 estimates, based on a plurality of query images to be acquired based on a plurality of times of photographing during performing a predetermined action, and a reference image indicating a person associated with a predetermined pose, a pose of a subject indicated in each of the plurality of query images.

For example, the estimation unit 115 estimates, based on a similarity (e.g., an overall similarity) derived by the similarity acquisition unit 114, a pose of a subject indicated in each of query images in time series.

Further, the estimation unit 115 may estimate, based on at least one frame image thinned from a frame image in time series, and a reference image, a pose of a subject indicated in the at least one thinned frame image.

In this case, the pose acquisition unit 113 acquires, from the image acquisition unit 111, at least one thinned frame image, and acquires a second model of a subject indicated in the frame image. The similarity acquisition unit 114 derives an overall similarity, based on a second model of a subject indicated in the frame image, and a first model of a person indicated in each of a plurality of reference images. Then, the estimation unit 115 estimates, based on the overall similarity derived by the similarity acquisition unit 114, a pose of a subject indicated in the at least one thinned frame image.

There are various methods, as a method of estimating a pose of a subject, based on a similarity by the estimation unit 115. Hereinafter, pose estimation methods 1 to 5 are described as examples of the method.

### (Pose Estimation Method 1)

For example, the estimation unit 115 may estimate, based on a reference image in which a similarity has a largest value among a positive example and a negative example, a pose of a subject indicated in a query image or a frame image. In this case, for example, in a case where a reference image whose similarity has a largest value is a positive example, the estimation unit 115 estimates that a pose of a subject is a predetermined pose associated with the reference image. In a case where a reference image whose similarity has a largest value is a negative example, the estimation unit 115 estimates that a pose of a subject is not a predetermined pose associated with the reference image.

### (Pose Estimation Method 2)

Further, for example, the estimation unit 115 may estimate, based on a positive example average value and a negative example average value, a pose of a subject indicated in a query image or a frame image. The positive example average value is an average value of similarities between a plurality of positive examples associated with a predetermined pose, and a query image or a frame image. The negative example average value is an average value of similarities between a plurality of negative examples associated with a predetermined pose, and a query image or a frame image.

In this case, for example, in a case where the positive example average value is larger than the negative example average value, the estimation unit 115 estimates that a pose of a subject is a predetermined pose associated with the reference image. In a case where the positive example average value is equal to or less than the negative example average value, the estimation unit 115 estimates that a pose of a subject is not a predetermined pose associated with the reference image.

### (Pose Estimation Method 3)

Furthermore, for example, the estimation unit 115 may perform image matching between a query image or a frame image, and a reference image, and estimate, based on a similarity between a reference image that has achieved matching in the image matching, and the query image or the frame image, a pose of a subject indicated in the query image or the frame image. In this case, the estimation unit 115 may estimate, based on a positive example average value and a negative example average value among the reference image that has achieved matching in the image matching, a pose of a subject indicated in the query image or the frame image.

Specifically, for example, in a case where the positive example average value is larger than the negative example average value among a reference image that has achieved matching in image matching, the estimation unit 115 estimates that a pose of a subject is a predetermined pose associated with the reference image. In a case where the positive example average value is equal to or less than the negative example average value among the reference image that has achieved matching in image matching, the estimation unit 115 estimates that a pose of a subject is not a predetermined pose associated with the reference image.

Note that, various known techniques may be applied to image matching. For example, the estimation unit 115 derives a similarity between images, based on a feature value or the like between a subject indicated in a query image or a frame image, and a person indicated in a reference image. The estimation unit 115 decides whether the query image or the frame image matches the reference image by comparing the similarity between the images with a threshold value. For example, in a case where a similarity between images is equal to or more than the threshold value, the estimation unit 115 decides to match (to be similar), and in a case where the similarity between the images is less than the threshold value, the estimation unit 115 decides not to match (not to be similar).

### (Pose Estimation Method 4)

The estimation unit 115 may estimate a pose of a subject without using a similarity and using only image matching.

For example, in a case where at least one positive example achieves image matching, the estimation unit 115 may estimate that a subject indicated in a query image or a frame image is in a predetermined pose associated with the reference image. Further, for example, in a case where at least one negative example achieves image matching, the estimation unit 115 may estimate that a subject indicated in a query image or a frame image is not in a predetermined pose associated with the reference image.

Furthermore, for example, the estimation unit 115 may estimate a pose of a subject, based on the number of matchings with respect to a positive example and a negative example that achieve image matching. In this case, for example, in a case where the number of matchings with respect to a positive example is larger than the number of matchings with respect to a negative example, the estimation unit 115 estimates that a subject indicated in a query image or a frame image is in a predetermined pose associated with the reference image. Further, for example, in a case where the number of matchings with respect to the positive example is equal to or less than the number of matchings with respect to the negative example, the estimation unit 115 estimates that a subject indicated in the query image or the frame image is not in the predetermined pose associated with the reference image.

In image matching, in a case where neither a query image nor a frame image matches both of a positive example and a negative example, the estimation unit 115 may decide that the query image or the frame image is different with respect to both of the positive example and the negative example, and may decide as the negative example.

### (Pose Estimation Method 5)

The estimation unit 115 may decide which one of a positive example and a negative example, a query image or the frame image matches (is similar to) by using a learning model that has learned by performing machine learning using a reference image. The learning model is a learning model that has learned by performing machine learning for deciding which one of a positive example and a negative example, a subject matches. In this case, the estimation unit 115 acquires a decision result as to which one of a positive example and a negative example, a query image or the frame image matches (is similar to) by inputting, to the learning model, image information including a query image indicating a subject or the frame image.

Input data to a learning model at a learning time include image information indicating a person. Further, in learning, it may be preferable to perform supervised learning including a label (correct answer) indicating which one of a positive example and a negative example, input data match.

The input unit 116 is a keyboard, a mouse, a touch panel, and the like that accept an input from a user.

The decision unit 117 decides whether a query image in which an estimation result is different is included in a plurality of query images, based on an estimation result in the estimation unit 115.

Specifically, for example, the decision unit 117 decides whether an estimation result regarding a plurality of query images corresponds to a predetermined false estimation pattern.

The false estimation pattern is a pattern of an estimation result related to a pose of a subject included in each of a plurality of query images. The false estimation pattern is, for example, defined in advance, and held in the storage unit 112.

The false estimation pattern may include a different estimation result with respect to another query image regarding at least one query image. Thus, in step S201, the decision unit 117 can decide whether a query image in which an estimation result is different is included in a plurality of query images by deciding whether an estimation result in the estimation unit 115 corresponds to the false estimation pattern.

The display unit 118 is a display or the like that displays various pieces of information. The display control unit 119 controls the display unit 118, and causes the display unit 118 to display various pieces of information. For example, in a case where the estimation unit 115 detects a subject in a predetermined pose, the display control unit 119 causes the display unit 118 to display a query image or a frame image in which a mark is attached to the subject. The mark is, for example, a rectangular frame surrounding a subject, and the like.

Further, for example, in a case where a query image in which an estimation result is different is included in a plurality of query images, based on a decision result in the decision unit 117, the display control unit 119 causes the display unit 118 to display a query image in which the different estimation is made.

### (Physical Configuration of Information Processing System S1)

The information processing system S1 is physically configured of the photographing unit 101, the information processing apparatus 100, and the analysis apparatus 102 that are connected to one another via the network N. Each of the photographing unit 101, the information processing apparatus 100, and the analysis apparatus 102 is configured of a physically different single apparatus. The photographing unit 101 is, for example, a camera.

Note that, the information processing apparatus 100 and the analysis apparatus 102 may be configured of a physically single apparatus, and, in this case, the information processing apparatus 100 and the analysis apparatus 102 are connected to each other by using an internal bus 1010 to be described later, in place of the network N. Further, either or both of the information processing apparatus 100 and the analysis apparatus 102 may be physically configured of a plurality of apparatus connected to each other via an appropriate communication line such as the network N.

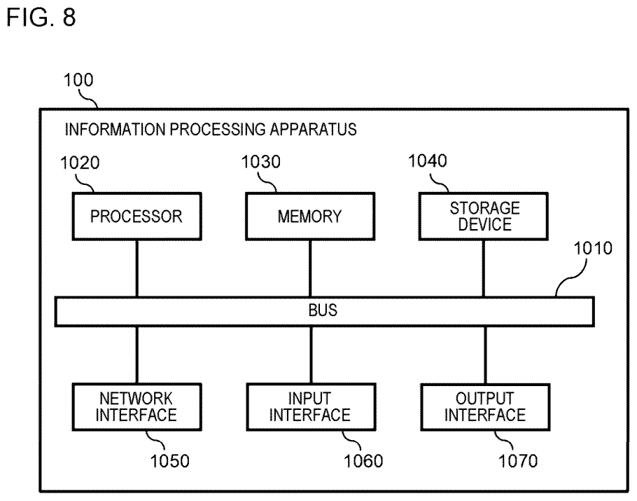

FIG. 8 is a diagram illustrating a physical configuration example of the information processing apparatus 100 according to the present example embodiment. The information processing apparatus 100 is, for example, a general-purpose computer. The information processing apparatus 100 includes the bus 1010, a processor 1020, a memory 1030, a storage device 1040, a network interface 1050, an input interface 1060, and an output interface 1070.

The bus 1010 is a data transmission path along which the processor 1020, the memory 1030, the storage device 1040, the network interface 1050, the input interface 1060, and the output interface 1070 mutually transmit and receive data. However, a method of mutually connecting the processor 1020 and the like is not limited to bus connection.

The processor 1020 is a processor to be achieved by a central processing unit (CPU), a graphics processing unit (GPU), or the like.

The memory 1030 is a main storage apparatus to be achieved by a random access memory (RAM) or the like.

The storage device 1040 is an auxiliary storage apparatus to be achieved by a hard disk drive (HDD), a solid state drive (SSD), a memory card, a read only memory (ROM), or the like. The storage device 1040 stores a program module for achieving each function of the information processing apparatus 100. Each function associated with a program module is achieved by causing the processor 1020 to read each program module in the memory 1030 and execute the program module.

The network interface 1050 is an interface for connecting the information processing apparatus 100 to the network N.

The input interface 1060 is an interface for inputting information by a user. The input interface 1060 is, for example, configured of one or a plurality of a keyboard, a mouse, a touch panel, and the like.

The output interface 1070 is an interface for presenting information to a user. The output interface 1070 is, for example, configured of a liquid crystal panel, an organic electro-luminescence (EL) panel, or the like.

The analysis apparatus 102 is physically a general-purpose computer, for example. The analysis apparatus 102 is physically configured substantially similarly to the information processing apparatus 100 (see FIG. 8)

The storage device 1040 of the analysis apparatus 102 stores a program module for achieving each function of the analysis apparatus 102. Each function associated with a program module is achieved by causing the processor 1020 of the analysis apparatus 102 to read each program module in the memory 1030 and execute the program module. The network interface 1050 of the analysis apparatus 102 is an interface for connecting the analysis apparatus 102 to the network N. Except for these points, the analysis apparatus 102 may be physically configured similarly to the information processing apparatus 100.

### (Operation of Information Processing System S1)

The information processing system S1 according to the present example embodiment performs information processing for estimating a pose of a subject included in a query image. The information processing to be performed by the information processing system S1 includes pose estimation processing and estimation support processing.

The pose estimation processing is processing of estimating a pose of a subject included in a query image by using a reference image associated with a predetermined pose. The estimation support processing is processing for supporting estimation of a pose of a subject.

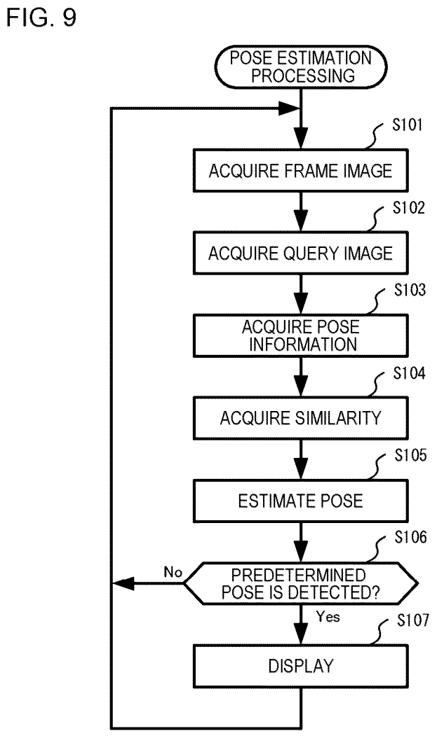

FIG. 9 is a flowchart illustrating one example of the pose estimation processing according to the present example embodiment. The pose estimation processing is, for example, performed during operation of the information processing system S1.

The image acquisition unit 111 acquires a plurality of frame images in time series (step S101). The image acquisition unit 111 stores the acquired frame images.

Specifically, for example, the image acquisition unit 111 successively acquires a plurality of frame images in time series during a time period from time T1 before time T2. It is assumed that time T2−time T1=time interval ΔT.

The image acquisition unit 111 acquires a query image by thinning out a part of a plurality of frame images acquired in step S101 (step S102).

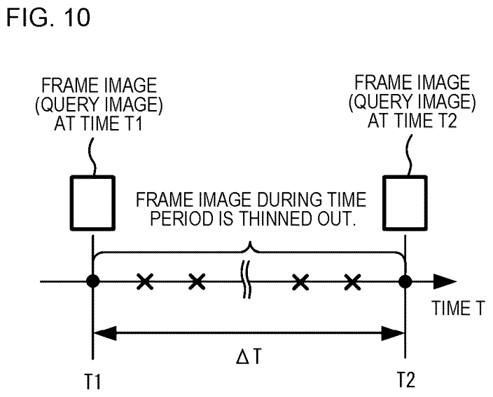

Specifically, for example, the image acquisition unit 111 thins out a part of a plurality of frame images in accordance with a predetermined rule. For example, FIG. 10 is a diagram illustrating one example of a method of thinning out a part from a plurality of frame images. As illustrated in FIG. 10, the image acquisition unit 111 thins out a frame image acquired during a predetermined time interval ΔT (except for a time at both ends). This allows the image acquisition unit 111 to acquire a query image in time series for the predetermined fixed time interval ΔT. Note that, a method of acquiring a query image by thinning out a part from a plurality of query images is not limited thereto, and for example, the time interval ΔT may not be fixed, and may be changed according to an operation mode (a mode in which a subject is tracked, or a mode in which a pose of a subject is detected). Further, the query image may be a plurality of frame images not being thinned.

The pose acquisition unit 113 acquires first pose information based on a plurality of reference images associated with a predetermined pose, and second pose information based on the query image acquired in step S102 (step S103).

Specifically, for example, the pose acquisition unit 113 acquires, from the storage unit 112, a plurality of reference images associated with a predetermined pose. In a case where the predetermined pose is a call pose, and the reference information 112a illustrated in FIG. 5 is stored in the storage unit 112, the pose acquisition unit 113 acquires the reference images 1 to 7. The pose acquisition unit 113 transmits the acquired reference images 1 to 7 to the analysis apparatus 102. In response to this, the analysis apparatus 102 generates the first pose information including a first model of a person indicated in each of the reference images 1 to 7, and transmits the generated first pose information to the information processing apparatus 100. The pose acquisition unit 113 acquires the first pose information from the analysis apparatus 102.

The pose acquisition unit 113 acquires, from the image acquisition unit 111, the query image acquired in step S102. The pose acquisition unit 113 transmits the acquired query image to the analysis apparatus 102. In response to this, the analysis apparatus 102 generates the second pose information including a second model of a subject indicated in the query image, and transmits the generated second pose information to the information processing apparatus 100. The pose acquisition unit 113 acquires the second pose information from the analysis apparatus 102.

The similarity acquisition unit 114 derives a similarity between each first model included in each of first pose information and second pose information acquired in step S103, and the second model (step S104).

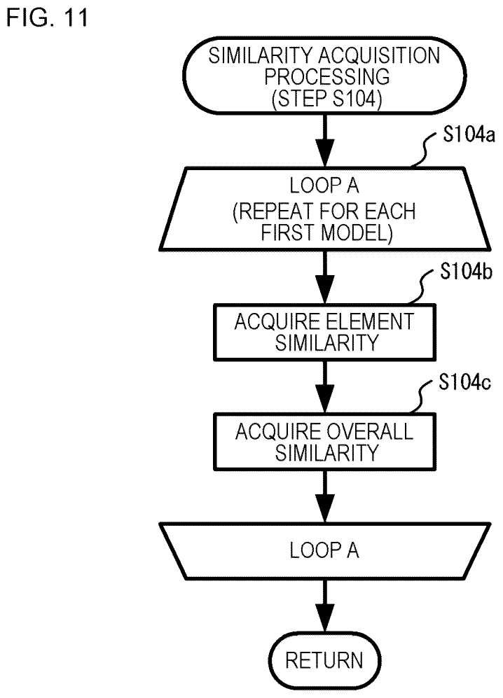

FIG. 11 is a flowchart illustrating a detailed example of similarity acquisition processing (step S104) according to the present example embodiment.

The element computation unit 114b repeats steps S104b to S104c for each first model included in the first pose information acquired in step S103 (step S104a).

The element computation unit 114b derives an element similarity being a similarity for each model element associated between the first model and the second model (step S104b).

The overall computation unit 114a acquires the weight information 112b stored in the storage unit 112, and derives an overall similarity between the first model and the second model, based on the element similarity for each model element derived in step S104b, and a weight (step S104c).

For example, the overall computation unit 114a derives a total sum of products of the element similarity of an associated model element, and a weight, and sets the total sum as the overall similarity.

The overall computation unit 114a derives each first model, the second model, and the overall similarity as a result of repeating steps S104b to S104c for each first model included in the first pose information acquired in step S103. After executing steps S104b to S104c for each first model included in the first pose information acquired in step S103, the overall computation unit 114a finishes a loop A (step S104a), and returns to the pose estimation processing.

FIG. 9 is referred to again.

The estimation unit 115 estimates, based on the query image acquired in step S102, and a plurality of reference images, a pose of the subject indicated in the query image (step S105).

For example, the estimation unit 115 estimates, based on the overall similarity between the query image acquired in step S102, and each of the reference images 1 to 7, a pose of the subject indicated in the query image. Note that, in step S105, the estimation unit 115 may use any of the above-described pose estimation methods 1 to 5, or may use a method other than the pose estimation methods 1 to 5 in order to estimate a pose of the subject.

The estimation unit 115 decides whether a predetermined pose is detected (step S106).

Specifically, for example, in a case where it is estimated that the subject indicated in the query image is in a predetermined pose in step S105, the estimation unit 115 decides that the predetermined pose is detected. In a case where it is estimated that the subject indicated in the query image is not in the predetermined pose in step S105, the estimation unit 115 decides that the predetermined pose is not detected.

In a case where it is decided that the predetermined pose is not detected (step S106; No), the image acquisition unit 111 executes step S101 again.

In a case where it is decided that the predetermined pose is detected (step S106; No), the display control unit 119 causes the display unit 118 to display that the predetermined pose is detected (step S107). Thereafter, the image acquisition unit 111 executes step S101 again.

In step S107, the display control unit 119 causes the display unit 118 to display the query image indicating the subject in the predetermined pose. As described above, the query image to be displayed herein may be an image in which a mark is attached to the subject.

A user can know that the subject in the predetermined pose is detected by viewing the display unit 118. For example, in a case where a person is in a call pose during operation of an ATM, since there is a possibility that the person is a person to be deceived or a suspicious person in a bank transfer fraud, a user can take measures, for example, such as notifying a security guard near the ATM to confirm, and the like.

Repeatedly performing pose estimation processing as described above enables to estimate a pose of a subject for each of query images in time series.

Herein, a plurality of frame images are, for example, an image based on photographing being performed while an ATM is operated. In this case, a plurality of frame images while a same person is operating an ATM, and a query image during the time period are images in time series and indicating a common subject.

Therefore, in a case where an estimated pose is different regarding a subject indicated in each of query images in time series (specifically, in a case where decision as to whether a pose is a predetermined pose is different), there is a possibility that false is included in any of estimation results in the pose estimation processing. In a case where a query image in which an estimation result is different is included in a plurality of query images, the display control unit 119 causes the display unit 118 to display a query image in which the different estimation is made. The display control unit 119 may store a query image in which the different estimation is made, and cause the display unit 118 to display the query image in which different estimation is made in a batch manner in response to an instruction of a user, or the like.

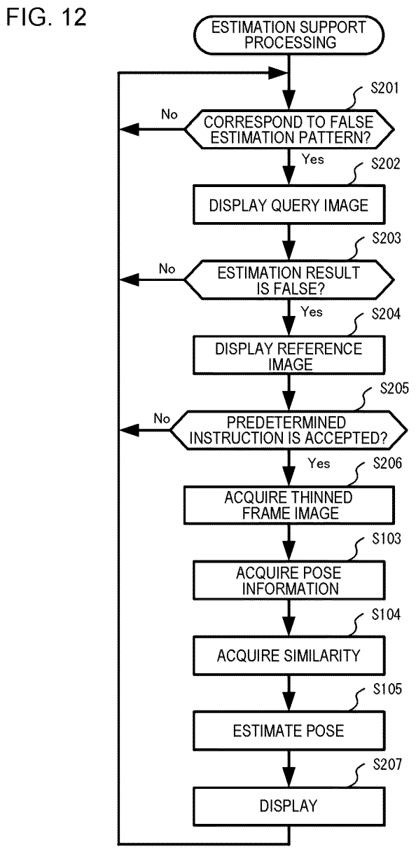

FIG. 12 is a flowchart illustrating one example of the estimation support processing according to the present example embodiment. The estimation support processing is processing for displaying a query image with a possibility of false estimation on a pose, in order to support estimation on a pose of a subject. The estimation support processing is performed while the pose estimation processing is performed. The estimation support processing may be repeatedly performed.

The decision unit 117 acquires an estimation result in step S105 being repeatedly executed, and decides whether an estimation result regarding a plurality of query images corresponds to a false estimation pattern (step S201). This enables to detect an estimation result corresponding to a false estimation pattern.

Specifically, for example, the false estimation pattern is a pattern of an estimation result regarding each of a predetermined number of query images in time series. The predetermined number herein may be 2 or more. As described above, the false estimation pattern may include a different estimation result with respect to another query image regarding at least one query image.

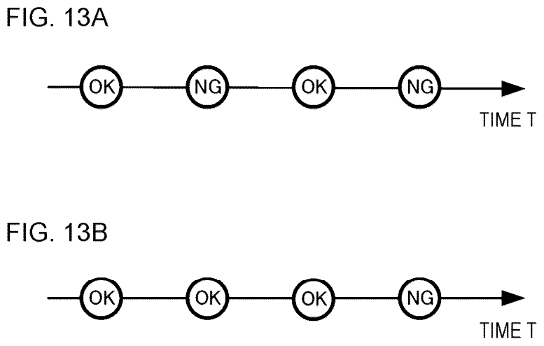

FIG. 13 is a diagram illustrating an example of the false estimation pattern as described above. In FIG. 13, “OK” indicates positive estimation, and “NG” indicates negative estimation. The positive estimation is an estimation result that the pose is a predetermined pose. The negative estimation is an estimation result that the pose is not a predetermined pose.

Pattern 1 illustrated in FIG. 13(a) indicates an example of a pattern in which an estimation result regarding each of four query images in time series is “OK/NG/OK/NG” in order. The pattern 1 is one example of a pattern in which an estimation result with respect to a query image in time series is repeatedly different a predetermined number of times or more. FIG. 13(a) illustrates an example in which the predetermined number of times is 2.

Since it is very rare that decision as to whether a subject makes a call by a mobile phone frequently changes regarding the subject while a same person is operating an ATM, it is very rare that decision as to whether the pose is a call pose frequently changes. The same is also applied to a wheelchair pose. Therefore, in a case where positive estimation and negative estimation are repeated regarding a query image indicating a subject while a same person is operating an ATM, it is highly likely that any of these estimation results is false. Therefore, it is possible to detect an estimation result with a high possibility of being false by detecting an estimation result in step S105 corresponding to the pattern 1.

Pattern 2 illustrated in FIG. 13(b) indicates an example of a pattern in which an estimation result regarding each of four query images in time series is “OK/OK/OK/NG” in order. The pattern 2 is one example of a pattern in which it is estimated that the pose is not a predetermined pose immediately after the pose is sequentially estimated to be the predetermined pose by a predetermined number or more with respect to the query image in time series. FIG. 13(b) illustrates an example in which the predetermined number is 3.

Regarding a subject while a same person is operating an ATM, for example, in a case where the subject is operating the ATM in response to an instruction of a deceiver in a bank transfer fraud, conceivably, it is highly likely that a call by a mobile phone continues until the operation at the ATM is finished, and there is a possibility that negative estimation is false. On the other hand, regarding a wheelchair pose, it is very rare that the wheelchair pose is finished, and it is highly likely that negative estimation is false. Therefore, detecting an estimation result in step S105 corresponding to the pattern 2 enables to detect an estimation result with a high possibility of being false.

As exemplified in the patterns 1 and 2, in a case where a different estimation result with respect to another query image is included regarding at least one query image, it is highly likely that false is included in the estimation result. Therefore, detecting a different estimation result with respect to another query image regarding at least one query image enables to detect an estimation result with a high possibility of being false.

Note that, the false estimation pattern is not limited to a pattern including a different estimation result with respect to another query image regarding at least one query image as exemplified in the patterns 1 and 2. The false estimation pattern may be a pattern including a query image in which an estimation result is different among a plurality of query images. This enables to detect an estimation result with a possibility of being false. As an example of the false estimation pattern as described above, a pattern including a different estimation result with respect to at least one of an earlier result and a later result in time series order (either or both of a pattern in which an estimation result regarding each of query images in time series is “OK/NG” in order, and a pattern in which an estimation result is “NG/OK”, in a case where the estimation result is represented by “OK” and “NG” similarly to FIG. 13) can be exemplified.

FIG. 12 is referred to again.

In a case where it is decided that an estimation result regarding a plurality of query images does not correspond to the false estimation pattern (step S201; No), the decision unit 117 repeats step S201.

In a case where it is decided that an estimation result regarding a plurality of query images corresponds to the false estimation pattern (step S201; Yes), the display control unit 119 acquires a query image associated with the false estimation pattern, and causes the display unit 118 to display the acquired query image (step S202). The query image associated with the false estimation pattern includes a query image in which different estimation is made with respect to another query image among the plurality of query images. At this occasion, the display control unit 119 may also cause to display an estimation result with respect to the acquired query image.

For example, it is assumed that the false estimation pattern corresponds to the pattern 1 illustrated in FIG. 13(a). In this case, by executing step S202, in a case where an estimation result with respect to a query image in time series is repeatedly different a predetermined number of times or more, the display control unit 119 causes the display unit 118 to display the query image in which the different estimation is repeatedly made. In this case, the display control unit 119 may cause the display unit 118 to display at least one query image corresponding to the pattern 1.

For example, it is assumed that the false estimation pattern corresponds to the pattern 2 illustrated in FIG. 13(b). In this case, by executing step S202, in a case where a pose is estimated not to be a predetermined pose immediately after the pose is sequentially estimated to be the predetermined pose by a predetermined number or more with respect to a query image in time series, the display control unit 119 causes the display unit 118 to display the query image being decided not to be the predetermined pose.

FIG. 12 is referred to again.

The display control unit 119 decides, based on, for example, a user input, whether an estimation result in step S105 regarding the query image displayed in step S202 is false (step S203).

Specifically, for example, a user confirms the query image displayed in step S202, and an estimation result with respect to the query image by viewing the display unit 118. Then, the user operates the input unit 116, and inputs whether the estimation result in step S105 regarding the displayed query image is false.

In a case where it is decided that the estimation result is not false (step S203; No), the display control unit 119 returns to step S201.

In a case where it is decided that the estimation result is false (step S203; Yes), the display control unit 119 causes the display unit 118 to display a reference image (step S204).

Specifically, for example, by executing step S204, in a case where a query image in which an estimation result is false is present among a query image in time series in which different estimation is made, the display control unit 119 causes the display unit 118 to display at least one among one or a plurality of reference images.

The reference image to be displayed herein is a reference image used in estimating in step S105 regarding the query image displayed in step S202. More specifically, the reference image to be displayed herein is a reference image indicating a person in which a similarity to a subject indicated in a query image in which false estimation is made satisfies a predetermined criterion. The predetermined criterion is that a similarity is highest, a similarity is equal to or more than a threshold value, and the like.

The display control unit 119 decides, based on, for example, a user input, whether a predetermined instruction for causing to display a thinned frame image is accepted (step S205).

In a case where it is decided that the predetermined instruction is not accepted (step S205; No), the display control unit 119 returns to step S201.

In a case where it is decided that the predetermined instruction is accepted (step S205; Yes), the display control unit 119 acquires, from the image acquisition unit 111, a frame image thinned in step S102 (step S206).

Specifically, for example, the display control unit 119 acquires at least one frame image thinned from a query image in time series in which different decision is made.

For example, it is assumed that a pattern corresponds to the pattern 1 illustrated in FIG. 13(a). In this case, for example, the display control unit 119 acquires at least one frame image being acquired and thinned by the image acquisition unit 111 during a time period between a query image in which positive estimation is made, and a query image in which negative estimation is made.

For example it is assumed that a pattern corresponds to the pattern 2 illustrated in FIG. 13(b). In this case, for example, the display control unit 119 acquires at least one frame image being acquired and thinned by the image acquisition unit 111 during a time period between a query image in which negative estimation is made, and a query image in which positive estimation is made.

Note that, the photographing unit 101 may store a frame image, and the display control unit 119 may acquire a thinned frame image from the photographing unit 101. This enables to reduce frame images to be transmitted from the photographing unit 101 to the information processing apparatus 100, thereby enabling to reduce a communication cost between the photographing unit 101 and the information processing apparatus 100.

FIG. 12 is referred to again.

The pose acquisition unit 113, the similarity acquisition unit 114, and the estimation unit 115 perform pieces of processing similar to steps S103 to S105 in the pose estimation processing.

Specifically, for example, in response to receiving an instruction of the display control unit 119, the pose acquisition unit 113 acquires first pose information based on a plurality of reference images associated with a predetermined pose, and second pose information based on the frame image acquired in step S206 (step S103).

The similarity acquisition unit 114 derives a similarity between each first model included in each of the first pose information and the second pose information acquired in step S103, and a second model (step S104).

The estimation unit 115 estimates, based on the frame image acquired in step S206, and a plurality of reference images, a pose of a subject indicated in the frame image (step S105). In step S105, the estimation unit 115 estimates, based on an overall similarity between the frame image acquired in step S206, and each of the reference images 1 to 7, a pose of the subject indicated in the query image.

Specifically, by executing step S105 herein, the estimation unit 115 estimates, based on at least one thinned frame image, and a reference image, a pose of the subject indicated in the frame image.

The display control unit 119 causes the display unit 118 to display the frame image acquired in step S206, and the estimation result in step S105 regarding the frame image (step S207), and returns to step S201.

By executing step S207, the display control unit 119 causes the display unit 118 to display at least one frame image thinned from a query image in time series in which different decision is made.

Performing the estimation support processing allows the display unit 118 to display a query image with a possibility of false estimation, a reference image associated with the query image, and a thinned frame image. Further, it is possible to cause the display unit 118 to display an estimation result as to whether a pose is a predetermined pose by using the thinned frame image and the reference image. This allows a user to know in which query image, false estimation is made. Further, a user can know by using which reference image, false estimation is made.

### Advantageous Effect

As described above, according to the present example embodiment, the information processing apparatus 100 includes the estimation unit 115, and the display control unit 119.

The estimation unit 115 estimates, based on a plurality of query images acquired by photographing a subject performing a predetermined action a plurality of times, and a reference image indicating a person associated with a predetermined pose, a pose of the subject indicated in each of the plurality of query images.

In a case where a query image in which an estimation result is different is included in the plurality of query images, the display control unit 119 causes the display unit 118 to display a query image in which the different estimation is made.

Generally, in a case where a query image in which an estimation result is different is included in a plurality of query images, there is a possibility that false is included in the estimation result. Displaying the query image as described above allows a user to refer to a query image in which different estimation is made. Then, a user can deal with in such a way as to improve accuracy of estimating a pose by confirming true and false of a pose estimated for each query image, deleting a reference image being a possible cause of false estimation, and the like. Therefore, it becomes possible to improve accuracy of estimating a pose of a subject indicated in an image.

According to the present example embodiment, the plurality of query images are a query image in time series. This enables to improve accuracy of estimating a pose of a subject indicated in the query image in time series.

According to the present example embodiment, in a case where an estimation result with respect to the query image in time series is repeatedly different a predetermined number of times or more, the display control unit 119 causes the display unit 118 to display the query image in which the different estimation is repeatedly made.

This enables to deal with in such a way as to improve accuracy of estimating a pose by confirming a query image with a high possibility of false estimation. Therefore, it becomes possible to improve accuracy of estimating a pose of a subject indicated in an image.

According to the present example embodiment, the reference image is one or plural. The information processing apparatus 100 includes the similarity acquisition unit 114 that derives a similarity related to a pose between a subject indicated in the query image, and a person indicated in the reference image, for each of combinations of the query image in time series, and the one or the plurality of reference images.

The estimation unit 115 estimates, based on the similarity, a pose of the subject indicated in each of the query images in time series. In a case where a query image in which an estimation result is false is present among the query image in time series in which the different estimation is repeatedly made, the display control unit 119 causes the display unit 118 to display the reference image indicating a person in which the similarity to the subject indicated in the query image in which the false estimation is made satisfies a predetermined criterion among the one or the plurality of reference images.

This enables to deal with in such a way as to improve accuracy of estimating a pose by confirming a reference image being likely to be a cause of false estimation, deleting a reference image being a possible cause of false estimation, and the like. Therefore, it becomes possible to improve accuracy of estimating a pose of a subject indicated in an image.

According to the present example embodiment, the information processing apparatus 100 includes the image acquisition unit 111 that acquires a frame image in time series to be acquired by photographing the subject sequentially timewise a plurality of times. The plurality of query images are frame images to be acquired by thinning out a part from the frame image in time series.

The display control unit 119 further causes the display unit 118 to display at least one frame image thinned from a query image in time series in which the different decision is made.

This enables to deal with in such a way as to improve accuracy of estimating a pose by confirming a frame image photographed at a close time with respect to a query image with a high possibility of false estimation. Therefore, it becomes possible to improve accuracy of estimating a pose of a subject indicated in an image.

According to the present example embodiment, the estimation unit 115 further estimates, based on the at least one thinned frame image, and the reference image, a pose of a subject indicated in the frame image.

This enables to deal with in such a way as to improve accuracy of estimating a pose by confirming an estimation result regarding a frame image photographed at a close time with respect to a query image with a high possibility of false estimation. Therefore, it becomes possible to improve accuracy of estimating a pose of a subject indicated in an image.

According to the present example embodiment, in a case where a pose is estimated not to be the predetermined pose immediately after the pose is sequentially estimated to be the predetermined pose by a predetermined number or more with respect to the query image in time series, the display control unit 119 causes the display unit 118 to display a query image in which the pose is decided not to be the predetermined pose.

This enables to deal with in such a way as to improve accuracy of estimating a pose by confirming a query image with a high possibility of false estimation. Therefore, it becomes possible to improve accuracy of estimating a pose of a subject indicated in an image.

According to the present example embodiment, the information processing apparatus 100 further includes the decision unit 117 that decides whether a query image in which an estimation result is different is included in the plurality of query images.

This enables to detect an estimation result with a high possibility of being false. Therefore, it becomes possible to improve accuracy of estimating a pose of a subject indicated in an image.

According to the present example embodiment, the decision unit 117 decides whether an estimation result regarding the plurality of query images corresponds to a predetermined false estimation pattern. The false estimation pattern is a pattern of an estimation result related to a pose of a subject included in each of a plurality of query images, and includes a different estimation result with respect to another query image regarding at least one query image. In a case where the decision unit 117 decides that an estimation result regarding the plurality of query images corresponds to the false estimation pattern, the display control unit 119 causes the display unit 118 to display a query image associated with the false estimation pattern.

This enables to detect an estimation result with a high possibility of being false, and confirm the estimation result. Then, it is possible to deal with in such a way as to improve accuracy of estimating a pose by confirming true and false of a pose estimated for each query image, deleting a reference image being a possible cause of false estimation, and the like. Therefore, it becomes possible to improve accuracy of estimating a pose of a subject indicated in an image.

According to the present example embodiment, the false estimation pattern includes at least one of a pattern in which an estimation result with respect to a query image in time series is repeatedly different a predetermined number of times or more, and a pattern being estimated not to be the predetermined pose immediately after a pose is sequentially estimated to be the predetermined pose by a predetermined number or more with respect to a query image in time series.

This enables to detect an estimation result with a high possibility of being false. Therefore, it becomes possible to improve accuracy of estimating a pose of a subject indicated in an image.

According to the present example embodiment, a plurality of times of photographing is performed while an ATM is operated. This enables to improve accuracy of estimating a pose of a subject indicated in an image photographed while the ATM is operated.

According to the present example embodiment, the plurality of query images are images indicating a common subject. This enables to improve accuracy of estimating a pose of the common subject indicated in the image.

According to the present example embodiment, the information processing apparatus 100 includes the estimation unit 115, and the display control unit 119.

The estimation unit 115 estimates, based on a query image to be acquired based on photographing during performing a predetermined action, and one or a plurality of reference images indicating a person associated with a predetermined pose, a pose of a subject indicated in the query image.

In a case where the estimation unit 115 makes false estimation, the display control unit 119 causes the display unit 118 to display a reference image indicating a person in which a similarity related to a pose of a subject indicated in a query image in which the false estimation is made satisfies a predetermined criterion among the one or the plurality of reference images.

This enables to deal with in such a way as to improve accuracy of estimating a pose by confirming a reference image being likely to be a cause of false estimation, deleting a reference image being a possible cause of false estimation, and the like. Therefore, it becomes possible to improve accuracy of estimating a pose of a subject indicated in an image.

### Example Embodiment 2

In the example embodiment 1, an example in which a plurality of times of photographing is performed during a timewise sequential (different) period has been described. The plurality of times of photographing may be photographing to be performed concurrently from two or more different directions.

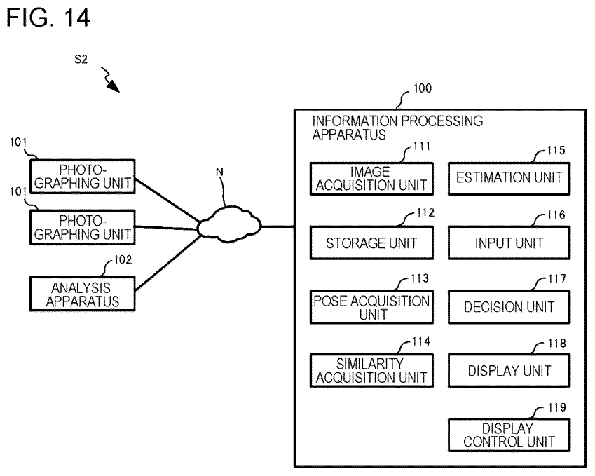

FIG. 14 is a diagram illustrating a detailed functional configuration example of an information processing system S2 according to the example embodiment 2. The information processing system S2 includes two photographing units 101, an information processing apparatus 100, and an analysis apparatus 102. Note that, the photographing units 101 may be three or more.

Each of the two photographing units 101 is, for example, a camera that photographs a common area such as a front of an ATM. Therefore, the two photographing units 101 can photograph a common subject concurrently from the different direction. Each of the photographing units 101 may be functionally and physically similar to the photographing unit 101 according to the example embodiment 1.

Each of the information processing apparatus 100 and the analysis apparatus 102 may be functionally and physically similar to that of the example embodiment 1. For example, in a case where a query image in which an estimation result is different is included in a plurality of query images, a display control unit 119 causes a display unit 118 to display a query image in which the different estimation is made. The information processing system S2 may be operated similarly to the information processing system S1 according to the example embodiment 1.

### Advantageous Effect

As described above, according to the present example embodiment, a plurality of times of photographing is photographing to be performed concurrently from two or more different directions.

This allows a user to deal with in such a way as to improve accuracy of estimating a pose by confirming true and false of a pose estimated for each query image by referring to a query image acquired by photographing concurrently and in which different estimation is made, deleting a reference image being a possible cause of false estimation, and the like. Therefore, it becomes possible to improve accuracy of estimating a pose of a subject indicated in an image.

In the foregoing, example embodiments and modification examples according to the present invention have been described with reference to the drawings, however, these are examples of the present invention, and various configurations other than the above can also be adopted.

Further, in a plurality of flowcharts used in the above description, a plurality of processes (pieces of processing) are described in order, however, the order of execution of processes to be performed in each example embodiment is not limited to the order of description. In each example embodiment, the illustrated order of processes can be changed within a range that does not adversely affect a content. Further, the above-described example embodiments and modification examples can be combined, as far as contents do not conflict with each other.

A part or all of the above-described example embodiments may also be described as the following supplementary notes, but is not limited to the following.
1. An information processing apparatus including:
   an estimation unit that estimates, based on a query image acquired by photographing a subject performing a predetermined action, and one or a plurality of reference images indicating a person associated with a predetermined pose, a pose of a subject indicated in the query image; and,
   in a case where the estimation unit makes false estimation, a display control unit that causes a display unit to display the reference image indicating a person in which a similarity related to a pose with respect to the subject indicated in a query image in which the false estimation is made satisfies a predetermined criterion among the one or the plurality of reference images.
2. An information processing apparatus including:
   an estimation unit that estimates, based on a plurality of query images acquired by photographing a subject performing a predetermined action a plurality of times, and a reference image indicating a person associated with a predetermined pose, a pose of the subject indicated in each of the plurality of query images; and,
   in a case where a query image in which an estimation result is different is included in the plurality of query images, a display control unit that causes a display unit to display a query image in which the different estimation is made.
3. The information processing apparatus according to supplementary note 2, wherein
   the plurality of query images are query images in time series.
4. The information processing apparatus according to supplementary note 3, wherein,
   in a case where an estimation result with respect to the query image in time series is repeatedly different a predetermined number of times or more, the display control unit causes the display unit to display a query image in which the different estimation is repeatedly made.
5. The information processing apparatus according to supplementary note 4, wherein
   the reference image is one or plural,
   the information processing apparatus further including
   a similarity acquisition unit that derives a similarity related to a pose between a subject indicated in the query image, and a person indicated in the reference image, for each of combinations of the query image in time series, and the one or the plurality of reference images, wherein
   the estimation unit estimates, based on the similarity, a pose of the subject indicated in each of the query images in time series, and,
   in a case where a query image in which an estimation result is false is present among the query image in time series in which the different estimation is repeatedly made, the display control unit causes the display unit to display the reference image indicating a person in which the similarity to a subject indicated in a query image in which the false estimation is made satisfies a predetermined criterion among the one or the plurality of reference images.
6. The information processing apparatus according to any one of supplementary notes 3 to 5, further including
   an image acquisition unit that acquires a frame image in time series to be acquired by photographing the subject timewise sequentially the plurality of times, wherein
   the plurality of query images are frame images to be acquired by thinning out a part from the frame image in time series, and
   the display control unit further causes the display unit to display at least one frame image thinned from a query image in time series in which the different decision is made.
7. The information processing apparatus according to supplementary note 6, wherein
   the estimation unit further estimates, based on the at least one thinned frame image, and the reference image, a pose of a subject indicated in the frame image.
8. The information processing apparatus according to supplementary note 3, wherein,
   in a case where a pose is estimated not to be the predetermined pose immediately after the pose is sequentially estimated to be the predetermined pose by a predetermined number or more with respect to the query image in time series, the display control unit causes the display unit to display a query image in which the pose is decided not to be the predetermined pose.
9. The information processing apparatus according to any one of supplementary notes 1 to 8, further including
   a decision unit that decides whether a query image in which an estimation result is different is included in the plurality of query images.
10. The information processing apparatus according to supplementary note 9, wherein
   the decision unit decides whether an estimation result regarding the plurality of query images corresponds to a predetermined false estimation pattern,
   the false estimation pattern is a pattern of an estimation result related to a pose of a subject included in each of a plurality of query images, and includes a different estimation result with respect to another query image regarding at least one query image, and,
   in a case where the decision unit decides that an estimation result regarding the plurality of query images corresponds to the false estimation pattern, the display control unit causes the display unit to display a query image associated with the false estimation pattern.
11. The information processing apparatus according to supplementary note 10, wherein
   the false estimation pattern includes at least one of a pattern in which an estimation result with respect to a query image in time series is repeatedly different a predetermined number of times or more, and a pattern being estimated not to be the predetermined pose immediately after a pose is sequentially estimated to be the predetermined pose by a predetermined number or more with respect to a query image in time series.
12. The information processing apparatus according to supplementary note 2, wherein
   the plurality of times of photographing is photographing to be performed concurrently from two or more different directions.
13. The information processing apparatus according to any one of supplementary notes 2 to 12, wherein
   the plurality of times of photographing is performed while an ATM is operated.
14. The information processing apparatus according to any one of supplementary notes 1 to 10, wherein
   the plurality of query images are images indicating the subject being common.
15. An information processing system including:
   the information processing apparatus according to any one of supplementary notes 1 to 14; and
   one or a plurality of photographing units that perform the plurality of times of photographing.
16. An information processing method including,
   by a computer:
   estimating, based on a plurality of query images to be acquired based on a plurality of times of photographing during performing a predetermined action, and a reference image indicating a person associated with a predetermined pose, a pose of a subject indicated in each of the plurality of query images; and,
   in a case where a query image in which an estimation result is different is included in the plurality of query images, causing a display unit to display a query image in which the different estimation is made.
17. A storage medium storing a program for causing a computer to execute:
   estimating, based on a plurality of query images to be acquired based on a plurality of times of photographing during performing a predetermined action, and a reference image indicating a person associated with a predetermined pose, a pose of a subject indicated in each of the plurality of query images; and,
   in a case where a query image in which an estimation result is different is included in the plurality of query images, causing a display unit to display a query image in which the different estimation is made.
18. A program for causing a computer to execute:
   estimating, based on a plurality of query images to be acquired based on a plurality of times of photographing during performing a predetermined action, and a reference image indicating a person associated with a predetermined pose, a pose of a subject indicated in each of the plurality of query images; and,
   in a case where a query image in which an estimation result is different is included in the plurality of query images, causing a display unit to display a query image in which the different estimation is made.

### REFERENCE SIGNS LIST

S1, S2 Information processing system
100 Information processing apparatus
101 Photographing unit
102 Analysis apparatus
111 Image acquisition unit
112 Storage unit
112a Reference information
112b Weight information
113 Pose acquisition unit
114 Similarity acquisition unit
114a Overall computation unit
114b Element computation unit
115 Estimation unit
116 Input unit
117 Decision unit
118 Display unit
119 Display control unit

What is claimed is:

1. An information processing apparatus comprising:
at least one memory configured to store instructions; and
at least one processor configured to execute the instructions to:
estimate, based on a plurality of query images acquired by capturing a subject performing a predetermined action a plurality of times, and a reference image including a person associated with a predetermined pose, a pose of the subject indicated in each of the plurality of query images; and,
cause a display, in a case where a query image in which an estimation result is different is included in the plurality of query images, to display a query image in which the different estimation is made.

2. The information processing apparatus according to claim 1, wherein
the plurality of query images are query images in time series.

3. The information processing apparatus according to claim 2, wherein,
the at least one processor is configured to execute the instructions to,
in a case where an estimation result with respect to the query image in time series is repeatedly different a predetermined number of times or more, cause the display to display a query image in which the different estimation is repeatedly made.

4. The information processing apparatus according to claim 3, wherein
the reference image is one or plural,
the at least one processor configured to execute the instructions to:
derive a similarity related to a pose between a subject indicated in the query image, and a person indicated in the reference image, for each of combinations of the query image in time series, and the one or the plurality of reference images; and
estimate, based on the similarity, a pose of the subject indicated in each of the query images in time series; and,
in a case where a query image in which an estimation result is false is present among the query image in time series in which the different estimation is repeatedly made, cause the display to display the reference image indicating a person in which the similarity to a subject indicated in a query image in which the false estimation is made satisfies a predetermined criterion among the one or the plurality of reference images.

5. The information processing apparatus according to claim 2, wherein
the at least one processor configured to execute the instructions to:
acquire a frame image in time series to be acquired by capturing the subject timewise sequentially a plurality of times, wherein
the plurality of query images are frame images to be acquired by thinning out a part from the frame image in time series; and
cause the display to display at least one frame image thinned from a query image in time series in which the different decision is made.

6. The information processing apparatus according to claim 5, wherein
the at least one processor configured to execute the instructions to:
estimate, based on the at least one thinned frame image, and the reference image, a pose of a subject indicated in the frame image.

7. The information processing apparatus according to claim 2, wherein,
the at least one processor is configured to execute the instructions to,
in a case where a pose is estimated not to be the predetermined pose immediately after the pose is sequentially estimated to be the predetermined pose by a predetermined number or more with respect to the query image in time series, cause to display a query image in which the pose is decided not to be the predetermined pose.

8. The information processing apparatus according to claim 1, wherein
the at least one processor configured to execute the instructions to:
decide whether a query image in which an estimation result is different is included in the plurality of query images.

9. The information processing apparatus according to claim 8, wherein
the at least one processor configured to execute the instructions to:
decide whether an estimation result regarding the plurality of query images corresponds to a predetermined false estimation pattern,
the false estimation pattern being a pattern of an estimation result related to a pose of a subject included in each of a plurality of query images, and including a different estimation result with respect to another query image regarding at least one query image; and,
in a case of being decided that an estimation result regarding the plurality of query images corresponds to the false estimation pattern, cause the display to display a query image associated with the false estimation pattern.

10. The information processing apparatus according to claim 9, wherein
the false estimation pattern includes at least one of a pattern in which an estimation result with respect to a query image in time series is repeatedly different a predetermined number of times or more, and a pattern being estimated not to be the predetermined pose immediately after a pose is sequentially estimated to be the predetermined pose by a predetermined number or more with respect to a query image in time series.

11. The information processing apparatus according to claim 1, wherein
the plurality of times of capturing is performed concurrently from two or more different directions.

12. The information processing apparatus according to claim 1, wherein
the plurality of times of capturing is performed while an automated teller machine is operated.

13. The information processing apparatus according to claim 1, wherein
the plurality of query images are images indicating the subject being common.

14. An information processing system comprising:
the information processing apparatus according to claim 1; and
one or a plurality of capturing units that perform the plurality of times of capturing.

15. An information processing method comprising,
by a computer:
estimating, based on a plurality of query images acquired by capturing a subject performing a predetermined action a plurality of times, and a reference image including a person associated with a predetermined pose, a pose of the subject indicated in each of the plurality of query images; and,
cause a display, in a case where a query image in which an estimation result is different is included in the plurality of query images, to display a query image in which the different estimation is made.

16. A non-transitory computer readable medium storing a program for causing a computer to execute:
estimating, based on a plurality of query images acquired by capturing a subject performing a predetermined action a plurality of times, and a reference image including a person associated with a predetermined pose, a pose of the subject indicated in each of the plurality of query images; and,
cause a display, in a case where a query image in which an estimation result is different is included in the plurality of query images, causing a display unit to display a query image in which the different estimation is made.
